(19) United States
(12) Patent Application Publication
(10) Pub. No.: US 2007/0040808 A1
(43) Pub. Date: Feb. 22, 2007

(54) User configurable button

(75) Inventor: Guan Chuan Choo, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 11/210,162

(22) Filed: Aug. 22, 2005

(51) Int. Cl. G09G 5/00

(52) U.S. Cl. 345/172

(57) ABSTRACT

A user configurable button (20) for a portable media player device (10), wherein the button (20) is configurable by associating at least one action with the button (20) in response to pressing and holding down the button (20) at least once, and subsequent pressing of the button (20) at least once causes the portable media player device (10) to perform the at least one associated action.

### TECHNICAL FIELD

The invention concerns a user configurable button for a portable media player device.

### BACKGROUND OF THE INVENTION

There has been a trend to make portable media player devices smaller in size. This facilitates portability and convenience when traveling. Due to the smaller size, the surface area of the device is limited and thus not all the functions of the device may be presented and accessed directly from the buttons of the device. Manufacturers tend to assign the most popular or essential functions of the device to the buttons.

It has been recognized that not all users are alike. Some users are technically more savvy than others, and each user has their own unique preferences. Also, users use their device specifically to suit their circumstances or environmental conditions. For example, it is expected a jogger uses their device differently to an office worker catching public transport to work or a university student waiting between lectures.

There is a desire to provide users with the ability to individualise and customize their portable media player device in a user friendly manner.

### SUMMARY OF THE INVENTION

In a first preferred aspect, there is provided a user configurable button for a portable media player device, wherein the button is configurable by associating at least one action with the button in response to pressing and holding down the button at least once, and subsequent pressing of the button at least once causes the portable media player device to perform the at least one associated action.

The button may be upgraded by firmware to enable new actions to be associated with the button.

The at least one action may be selected from any one of the group consisting of: jump to a screen, play this content, start recording, repeat A-B, equalizer preset, play mode, random play all, play next album, add to selected and set a bookmark. The screen may be any one of the group consisting of: albums screen, genre-artist screen and alphabetical order of songs screen.

In a second aspect, there is provided a method for configuring a predetermined button of a portable media player device, the device displaying a first screen, the method comprising:
pressing and holding down the predetermined button;
associating a default action with the predetermined button in response to holding down the predetermined button, where the default action is determined according to the first screen;
wherein subsequent pressing of the predetermined button causes the portable media player device to perform the associated action.

The association of the default action with the predetermined button may be confirmed by responses selected from the group consisting of: visual, audible, vibrational and a combination of the aforementioned.

The amount of time the predetermined button is held down for may be calculated and wherein the predetermined button is only configurable if the amount of time exceeds a predetermined amount of time, otherwise an existing associated action is performed.

If the amount of time exceeds an additional second predetermined amount of time, a menu may be presented on the first screen for an action to be selected and associated with the predetermined button.

In a third aspect, there is provided a method for configuring a predetermined button of a portable media player device, the method comprising:
pressing and holding down the predetermined button;
selecting an action to be associated with the predetermined button in response to holding down the predetermined button
associating the action with the predetermined button;
wherein subsequent pressing of the predetermined button causes the portable media player device to perform the associated action.

The action may be selected from a list of actions presented in a menu on the first screen.

The action may be any one of the group consisting of: jump to a screen, play this content, start recording, repeat A-B, equalizer preset, play mode, random play all, play next album, add to selected and set a bookmark.

The screen may be any one of the group consisting of: albums screen, genre-artist screen and alphabetical order of songs screen.

A series of actions may be associated with the predetermined button.

A second action or second series of actions may be performed when the predetermined button is pressed in rapid succession.

An action or series of actions to be associated with the predetermined button may depend on the screen that is displayed on the first screen when the predetermined button is pressed.

The amount of time the predetermined button is held down for may be calculated and wherein the predetermined button is only configurable if the amount of time exceeds a predetermined amount of time, otherwise the associated action is performed.

The equalizer preset may be switched each time the predetermined button is pressed, wherein if the current equalizer preset is normal, the next equalizer preset is the last selected equalizer preset; and if the current equalizer preset is not normal, the next equalizer preset is normal.

The play mode may be switched each time the predetermined button is pressed, wherein if the current play mode is normal, the next play mode is the last selected play mode; and if the current play mode is not normal, the next play mode is normal.

Subsequent play modes after the next play mode may be ordered according to frequency of use.

Frequency of use may be calculated according to at least one counter, the counter being incremented when the play mode is in use for at least a predetermined amount of time.

The at least one counter may be manually or automatically reset according to a predetermined condition.

Subsequent play modes after the next play mode may be in a user defined order.

Play modes may include normal, repeat track, repeat all, shuffle, or shuffle repeat.

Each time the play mode is switched, at least one response for each play mode may be selected from the group consisting of: visual, audible, vibrational and a combination of the aforementioned.

In a fourth aspect, there is provided a portable media player device comprising at least one user configurable button as described.

### BRIEF DESCRIPTION OF THE DRAWINGS

An example of the invention will now be described with reference to the accompanying drawings, in which:

FIG. 1 is a front view of a portable media player with a user configurable button in a preferred embodiment according to the present invention;

FIG. 2 is an activity diagram of configuring the user configurable button in a preferred embodiment according to the present invention; and

FIG. 3 is a flow diagram of various play mode switching scenarios when the user configurable button is pressed.

### DETAILED DESCRIPTION OF THE DRAWINGS

The following discussion is intended to provide a brief, general description of a suitable computing environment in which the present invention may be implemented. As those skilled in the art will appreciate, the invention may be practiced with other computer system configurations, including hand-held devices, multiprocessor systems, microprocessor-based or programmable consumer electronics, digital cameras, and the like.

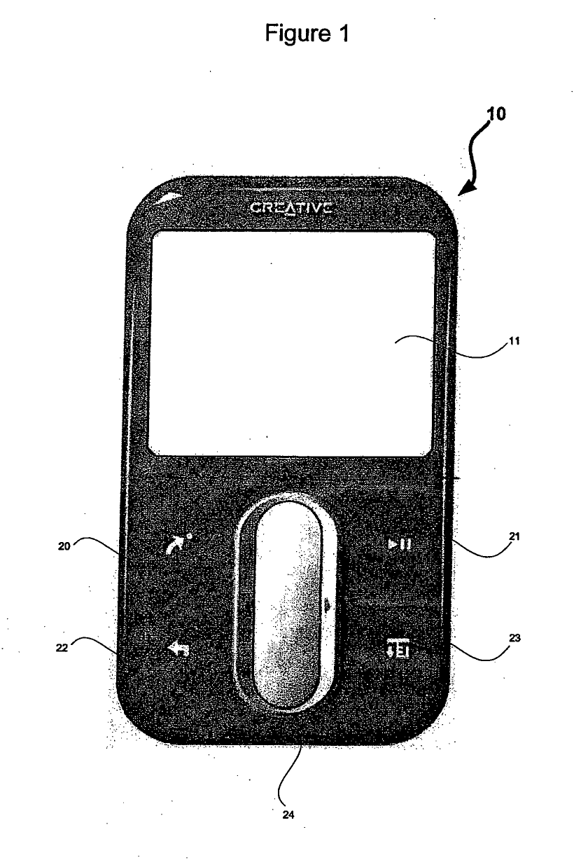

Referring to FIG. 1, there is provided a user configurable button 20 for a portable media player device 10 is provided. The button 20, hereinafter referred to as MY button 20, is configurable by associating an action with the button 20 in response to pressing and holding down the button. Subsequent pressing of the button 20 causes the portable media player device 10 to perform the associated action.

The device 10 generally comprises a display 11, and input/output A/V jacks (not shown). The device 10 also has a primary navigation button 24 which allows navigation and scrolling through menus and lists and also selection of menu items. Other buttons include a play/pause button 21, a return button 22, and a menu display button 23. The device 10 has a non-volatile storage medium such as, for example, solid state memory and hard disk drives, to store content, such as MP3NVMV audio files, MPEG/AVI video files and also non-media data. The device 10 also has a rechargeable battery to supply power to the device 10. To enable tactile sensing, the buttons 20, 21, 22, 23, 24 may be slightly raised above the front surface of the device 10. Alternatively, the buttons may remain flush with the front surface of the device 10 for a smoother and fashionable appearance.

MY button 20 provides fast access to a specific content or applications in the device 10. It is envisaged that the MY button 20 functions as a favorite button for the user to instantly activate their favorite action or function. MY button 20 functionality may be upgraded by firmware to enable new actions to be associated with the button 20.

The categories of actions which may be associated with MY button 20 generally include: jumping to a specific view, screen or application of the device 10; activating a specific action or function of the device apart from jumping to a specific screen; and playing a specific media file stored on the device 10.

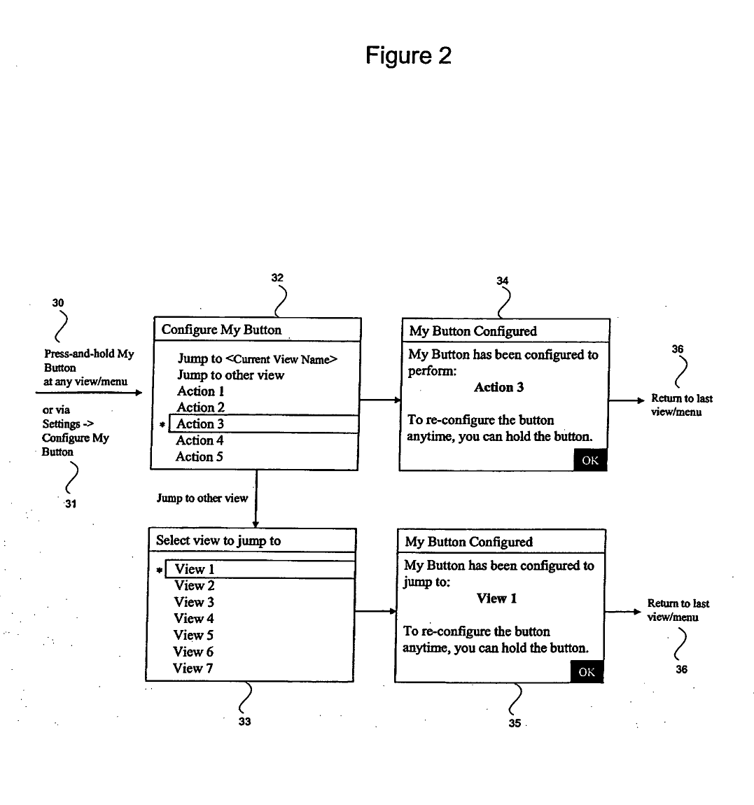

Referring to FIG. 2, MY button 20 may be configured in several different ways. The user performs a press-and-hold operation of the MY button 20 (30) at any time or in any screen of the device 10. A “Configure My Button” menu (32) is displayed to inform the user on which action may be selected as the preferred action to be associated with the MY button 20. Subsequently, a “My Button Configured” (34) confirmation screen appears and the display 11 then reverts to the last view or menu (36). After configuration of MY button 20, the associated action is performed when MY button 20 is pressed the next time. To re-configure MY button 20, a press-and-hold (30) is performed again to show the “Configure My Button” (32) menu again. Other ways to configure MY button 20 include navigating to the settings menu, and selecting and associating the preferred action for MY button 20 (31).

In an alternate scenario, MY button 20 may be quickly configured by performing a press-and-hold operation of MY button 20 for at least two seconds. This triggers the default action to occur. In one embodiment, the default action is to jump to the screen currently displayed when the press-and-hold operation is performed. A sound confirmation such as a beep is played when the association has been recorded. Also, the display 11 may also flash a confirmation message that the association has been recorded or the device 10 may briefly vibrate. If the press-and-hold operation of MY button 20 exceeds five seconds, the “Configure My Button” menu is displayed and the default action is bypassed. This allows other actions to be associated with the MY button 20 apart from jumping to a specific view action.

Referring again to FIG. 2, to configure MY button 20 to jump to any screen of the device 10, the user navigates to the desired screen, a press-and-hold operation (30) of the MY button 20 is performed to display the “Configure My Button” menu (32). From the menu, “Jump to this view” menu (33) item is selected. Subsequently, a “My Button Configured” (35) confirmation screen appears and the display 11 then reverts to the last view or menu (36). Subsequently, when MY button 20 is pressed, the device 10 takes the user directly to the desired screen.

The ability to jump directly to a desired screen enables users who like to playback the stored content according to albums to configure the MY button 20 to jump to the Albums view. Previously, users had to navigate through Menu->Music->Albums in order to access their albums. Alternatively, users who like to select songs by Genre-Artist may configure MY button 20 to jump directly to the Genre-Artists view. Previously, users had to navigate through Menu->Music->Genres->Artists in order to access this screen.

To configure MY button 20 to directly playback a specific file, the user navigates and browses through their file list and selects the specific file to be played. A press-and-hold operation of the MY button 20 displays the “Configure My Button” menu. From the menu, “Play this Content” menu item is selected. Subsequently, when MY button 20 is pressed, the specific file is played.

The ability to directly play a file, efficiently enables users who have purchased or downloaded a new song to play it immediately on demand without wasting any time browsing through their entire file list which may be lengthy. Alternatively, if the user has purchased or downloaded a new album, the user may configure MY button 20 to play all the songs from this album.

To configure MY button 20 to activate an action, the user performs a press-and-hold operation of the MY button 20 to display the “Configure My Button” menu. The preferred action is selected and associated with MY button 20. Subsequently, when MY button 20 is pressed, the associated action is performed. For example, actions which may be associated with MY button 20 include: RECORD (when the device 10 does not have a RECORD button), repeat A-B (when the device 10 does not have a repeat A-B button), EQ (switch among the available EQ presets), play Mode (to switch among the available play modes), random play all, play next album, add to selected, and set bookmark.

The ability to activate any action of the device 10 from MY button 20, efficiently enables fast access to a frequently used action/function, or users who like to play songs randomly to set MY button 20 to activate random play all for a play mode, or for users who use EQ presets often, configure MY button 20 to switch the EQ presets.

To educate the user about the features of MY button 20, one possibility is to display a message informing the user about the features of MY button 20 when it is first pressed on the display 11. After an action is associated with MY button 20, another message is displayed to confirm that the button 20 is configured, what action has been associated and how to re-configure MY button 20 on subsequent occasions.

By default, the confirmation message is always displayed to the user after the action is associated with MY button 20. If the user prefers, the confirmation message may be switched off.

MY button 20 is implemented at various levels. Firstly, MY button 20 may only be configured to perform one action. MY button 20 may be configured to perform more than one action. For example, a single press of MY button 20 triggers a first action, holding MY button 20 triggers a second action, double clicking or pressing of MY button in quick succession triggers a third action. Thirdly, MY button 20 may be configured to perform a different action depending on the current screen. The device 10 provides various levels of customization to the user.

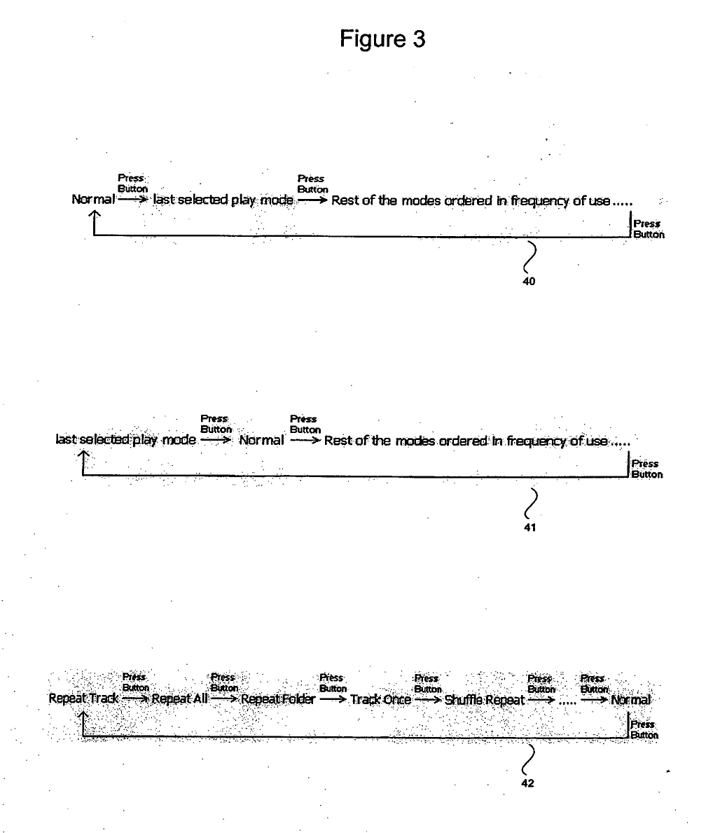

Referring to FIG. 3, MY button 20 may be configured for mode switching, for example, switching EQ presets or switching play modes. The mode sequence is adjustable, intelligent and responsive to actual usage. The MY button 20 supports fast switching between normal and the last selected mode. It also supports blind usage toggling between normal and the last selected mode. Blind usage is useful when traveling in a vehicle, jogging, or driving and the display 11 is not visible if the device 10 is carried in a pocket or bag or is out of sight. This feature may also aid the visually impaired in the use of the device 10. The mode switching offered by MY button 20 also improves efficiency by reducing the number of button presses for frequently used modes.

It is assumed that the majority of users predominantly use only one or two play modes. Similarly, only one or two EQ presets are predominantly used. MY button 20 supports blind usage and favorite play mode/EQ preset. When the current play mode is normal 40, that is, playing songs/videos in normal order, pressing MY button 20 changes the play mode to last selected play mode. If MY button 20 is pressed again, the play mode is switched to another play mode. The sequence of play modes may be ordered according to frequency of use. In such a case, a counter is provided in the device 10 which increments each time a play mode is selected and used. To accurately record the frequency of use for each play mode, the play mode must be in use for at least ten seconds before the counter for it is incremented. The counters may be stored in the non-volatile memory when the device 10 is idle or prior to power down of the device 10. When the most frequently used mode's counter reaches a predetermined maximum value, all mode counter values are decreased by the amount of the smallest non-zero counter value. If the smallest non-zero counter value is also zero, then the most frequently used mode's usage counter is halved. In other embodiments, the counters may automatically or manually reset by the user either by physical controls or electronic controls.

When the current play mode is not normal 41, pressing MY button 20 switches the play mode to normal play mode. If MY button 20 is pressed again, the play mode is switched to another play mode. The sequence of play modes may be ordered according to frequency of use.

Audio or vibration feedback is provided to indicate the selected play mode or EQ preset after switching to it 42. For example, a single beep for normal mode, or two beeps for the last selected mode.

In a typical scenario, for a user who uses only one play mode, for example, Repeat Track, toggling between Normal and Repeat Track can be performed any time without needing to look at the display 11. For a user who uses only two play modes, for example, Repeat Track and Shuffle All, to switch between the two modes requires only two presses of MY button 20. In another example, when a user has purchased or downloaded a new song, typically the play mode is set to Repeat Track for repeated listening of the new song. Once the user is tired of continually listening to the same song, MY button 20 is pressed once without needing to look at the display 11, which switches the play mode to normal play mode to continue playing other songs stored in the device 10.

Similarly, the typical scenario described above for switching play modes is applicable for EQ presets where various EQ presets can be selected using MY button 20 in the same manner.

MY button 20 may also be configured to initiate a series of steps, such as, for example, jumping to a particular view and selecting a particular EQ setting. Enabling MY button 20 to do this would require a multi-level configuration akin to that shown in FIG. 2.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. A user configurable button for a portable media player device, wherein the button is configurable by associating at least one action with the button in response to pressing and holding down the button at least once, and subsequent pressing of the button at least once causes the portable media player device to perform the at least one associated action.

2. The button according to claim 1, wherein the button is upgraded by firmware to enable new actions to be associated with the button.

3. The button according to claim 1, wherein the at least one action is selected from any one of the group consisting of: jump to a screen, play this content, start recording, repeat A-B, equalizer preset, play mode, random play all, play next album, add to selected and set a bookmark.

4. The button according to claim 3, wherein the screen is any one of the group consisting of: albums screen, genre-artist screen and alphabetical order of songs screen.

5. A method for configuring a predetermined button of a portable media player device, the device displaying a first screen, the method comprising:
pressing and holding down the predetermined button;
associating a default action with the predetermined button in response to holding down the predetermined button, where the default action is determined according to the first screen;
wherein subsequent pressing of the predetermined button causes the portable media player device to perform the associated action.

6. The method according to claim 5, wherein the association of the default action with the predetermined button is confirmed by responses selected from the group consisting of: visual, audible, vibrational and a combination of the aforementioned.

7. The method according to claim 5, wherein the amount of time the predetermined button is held down for is calculated and wherein the predetermined button is only configurable if the amount of time exceeds a predetermined amount of time, otherwise an existing associated action is performed.

8. The method according to claim 7, wherein if the amount of time exceeds an additional second predetermined amount of time, a menu is presented on the first screen for an action to be selected and associated with the predetermined button.

9. A method for configuring a predetermined button of a portable media player device, the method comprising:
pressing and holding down the predetermined button;
selecting an action to be associated with the predetermined button in response to holding down the predetermined button
associating the action with the predetermined button;
wherein subsequent pressing of the predetermined button causes the portable media player device to perform the associated action.

10. The method according to claim 9, wherein the action is selected from a list of actions presented in a menu on the first screen.

11. The method according to claim 10, wherein the action is any one of the group consisting of: jump to a screen, play this content, start recording, repeat A-B, equalizer preset, play mode, random play all, play next album, add to selected and set a bookmark.

12. The method according to claim 11, wherein the screen is any one of the group consisting of: albums screen, genre-artist screen and alphabetical order of songs screen.

13. The method according to claim 9, wherein a series of actions is associated with the predetermined button.

14. The method according to claim 9, wherein a second action or second series of actions is performed when the predetermined button is pressed in rapid succession.

15. The method according to claim 9, wherein an action or series of actions to be associated with the predetermined button depends on the screen that is displayed on the first screen when the predetermined button is pressed.

16. The method according to claim 9, wherein the amount of time the predetermined button is held down for is calculated and wherein the predetermined button is only configurable if the amount of time exceeds a predetermined amount of time, otherwise the associated action is performed.

17. The method according to claim 11, wherein the equalizer preset is switched each time the predetermined button is pressed, wherein if the current equalizer preset is normal, the next equalizer preset is the last selected equalizer preset; and if the current equalizer preset is not normal, the next equalizer preset is normal.

18. The method according to claim 11, wherein the play mode is switched each time the predetermined button is pressed, wherein if the current play mode is normal, the next play mode is the last selected play mode; and if the current play mode is not normal, the next play mode is normal.

19. The method according to claim 18, wherein subsequent play modes after the next play mode are ordered according to frequency of use.

20. The method according to claim 19, wherein frequency of use is calculated according to at least one counter, the counter being incremented when the play mode is in use for at least a predetermined amount of time.

21. The method according to claim 20, wherein the at least one counter is manually or automatically reset according to a predetermined condition.

22. The method according to claim 18, wherein subsequent play modes after the next play mode is in a user defined order.

23. The method according to claim 11, wherein play modes include normal, repeat track, repeat all, shuffle, or shuffle repeat.

24. The method according to claim 18, wherein each time the play mode is switched, at least one response for each play mode is selected from the group consisting of: visual, audible, vibrational and a combination of the aforementioned.

25. A portable media player device comprising at least one user configurable button according to claim 1.
